(19) United States
(12) Patent Application Publication
(10) Pub. No.: US 2002/0131103 A1
(43) Pub. Date: Sep. 19, 2002

(54) Method and system for reconfiguring a network element such as an optical network element

(76) Inventor: Nicholas Bambos, San Mateo, CA (US)

Correspondence Address: BRINKS HOFER GILSON & LIONE, P.O. BOX 10395, CHICAGO, IL, 60610, US

(21) Appl. No.: 09/809,861

(22) Filed: Mar. 16, 2001

(51) Int. Cl. H04B 10/20; H04J 14/00; H04J 14/02

(52) U.S. Cl. 359/118; 359/127

(57) ABSTRACT

The preferred embodiments described herein provide a method and system for reconfiguring a network element such as an optical network element. In one preferred embodiment, a reconfiguration frame is transmitted from a source node to an optical network element via a lightpath, and the optical network element is reconfigured while the reconfiguration frame crosses the optical network element. In this way, information bits transmitted by the source node after the reconfiguration frame are not dropped when the optical network element is reconfigured. One advantage associated with these preferred embodiments is that they can provide agile, seamless reconfiguration of lightpaths in core/backbone optical communication networks. Other preferred embodiments are provided, and each of the preferred embodiments described herein can be used alone or in combination with one another. In some embodiments, reconfiguration frames are used with electronic network elements instead of or in addition to optical network elements.

### BACKGROUND

Reconfigurable optical network elements, such as wavelength cross-connects (WxCs), are used in wavelength-division multiplexed (WDM) optical communication networks to reconfigure lightpaths to adapt to varying traffic demands. The continuity of a lightpath is disrupted as the WxC dismantles and re-establishes a lightpath's fiber and wavelength permutation state, and information bits crossing the WxC during this WxC reconfiguration time interval are “dropped.” If electronics intervene in the continuity of a lightpath (e.g., at O-E-O nodes), incoming information bits on each lightpath to a WxC can be buffered into an electronic buffer to avoid the bit-drop caused by the disruption of lightpath continuity during reconfiguration of the WxC. After the WxC is reconfigured and communication continuity is again established, the buffered information bits are released to the WxC. While suitable for low-rate traffic flows (such as OC-3 and OC-12), this approach is not suitable for high-rate traffic flows (such as OC-192 and OC-768) for backbone/core optical networks, especially those that employ WxC technologies that handle large aggregate throughputs by allowing a significant number of Tb/s fibers to be interconnected through a single WxC. The relatively high-rate of these traffic flows and the relatively slow reconfiguration speeds of WxCs require the use of very large buffers operating at high memory access speeds, resulting in an expensive solution that stresses its electronic components to their limits (if at all feasible). Buffering information bits will also be very difficult in next-generation networks with full optical switching with no intervening electronic buffers.

This problem has led to the use of the slow legacy reconfiguration method of establishing a new lightpath in parallel with an existing lightpath, as described in U.S. Pat. No. 6,075,631 to Bala et al. See also U.S. Pat. No. 6,073,248 to Doshi et al. In this approach, new information bits are allocated to the new lightpath instead of the existing lightpath. Traffic previously allocated to the existing lightpath is allowed to cross the WxC, and once the portion of the existing lightpath leading to the WxC is emptied of information bits, the WxC's resources that supported the existing lightpath (e.g, fiber wavelengths and WxC ports) are released. Among the disadvantages to this approach are that the capacity of the existing lightpath is wasted during the reconfiguration process and that the process of turning on and turning off lightpaths can take a relatively long time. Both of these disadvantages become linearly worse as the length of the lightpaths increase. Additionally, while this approach may be acceptable for lightpaths that are established for relatively long times, it may not be appropriate for situations where lightpaths are rapidly reconfigured.

Given the disadvantages described above, dynamic reconfiguration of lightpaths across a network is often a process of high overhead and disruption, which reduces the agility and frequency with which it can be performed. There is a need, therefore, for an improved method and system for reconfiguring an optical network element.

### SUMMARY

By way of introduction, the preferred embodiments described below provide a method and system for reconfiguring a network element such as an optical network element. In one preferred embodiment, a reconfiguration frame is transmitted from a source node to an optical network element via a lightpath, and the optical network element is reconfigured while the reconfiguration frame crosses the optical network element. In this way, information bits transmitted by the source node after the reconfiguration frame are not dropped when the optical network element is reconfigured. One advantage associated with these preferred embodiments is that they can provide agile, seamless reconfiguration of lightpaths in core/backbone optical communication networks. Other preferred embodiments are provided, and each of the preferred embodiments described herein can be used alone or in combination with one another. In some embodiments, reconfiguration frames are used with electronic network elements instead of or in addition to optical network elements.

The preferred embodiments will now be described with reference to the attached drawings.

### BRIEF DESCRIPTION OF THE DRAWINGS

FIG. 1 is an illustration of a network of a preferred embodiment.

FIG. 2 is an illustration of a node of the network illustrated in FIG. 1.

FIGS. 3A-H illustrate a method of a preferred embodiment for reconfiguring a single WxC supporting two lightpaths.

FIGS. 4A-G illustrate a method of a preferred embodiment for reconfiguring three WxCs supporting four lightpaths.

FIG. 5 illustrates the use of a reconfiguration control engine of a preferred embodiment to control reconfiguration of the network shown in FIGS. 4A-G.

FIG. 6 is a flow chart illustrating a reconfiguration algorithm of a preferred embodiment.

FIGS. 7A-B illustrate WxC configuration with lightpath cycles.

FIGS. 8A-D illustrate a method of a preferred embodiment for reconfiguring three WxCs using a single set of reconfiguration frames.

### DETAILED DESCRIPTION OF THE PRESENTLY PREFERRED EMBODIMENTS

Network Overview

Turning now to the drawings, FIG. 1 is an illustration of an exemplary wavelength-division multiplexed (WDM) optical communication network 10 of a preferred embodiment. As shown in FIG. 1, this network 10 comprises a plurality of nodes 100, each comprising an optical network element 110 operating in the optical domain, an electronic network element 120 operating in the electrical domain, and an interface module 130 for facilitating communication between the optical network element 110 and the electrical network element 120. The nodes 100 have ingress and egress ports that allow information bits to flow into and out of the nodes (e.g., to users located near the nodes), and optical network elements 110 of different nodes 100 are connected together with one or more optical fibers 140. As used herein, the term “connected with” means directly connected with or indirectly connected with through one or more named or unnamed elements.

Information bits are sent from a source node to a destination node via a lightpath in the optical fiber(s) connecting the source and destination nodes. The term “information bits” is intended to broadly refer to a digital representation of information transmitted from a source node to a destination node. Information bits can represent, for example, data (e.g., email), audio information (e.g., voice traffic, music files), and/or video information. The terms “traffic” and “communication stream” are used interchangeably with the term “information bits.” A lightpath from a source node to a destination node can use one or more optical fibers and cross one or more intermediate optical network elements. For example, the lightpath connecting source node A with destination node D uses optical fibers A-B, B-C, and C-D and traverses the optical network elements in intermediate nodes B and C. A lightpath uses a single wavelength on each fiber. While a lightpath can use different wavelengths on different fibers, no two distinct lightpaths can use the same wavelength on the same fiber.

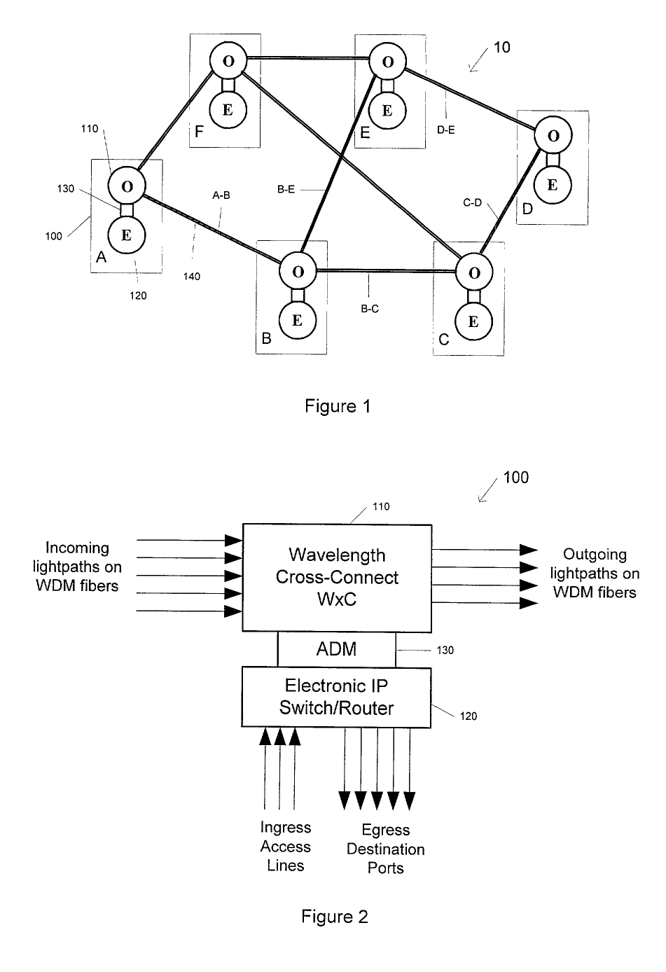

FIG. 2 is an illustration of one of the nodes 100 in the network 10. Here, the optical network element 110 is a wavelength cross-connect (WxC), the interface module 130 is an add/drop multiplexer (ADM), and the electronic network element 120 is an electronic IP switch/router. The WxC 110 switches the wavelength of an incoming lightpath to the same or some other outgoing wavelength, connecting the two and establishing continuity of the communication stream between the two wavelengths on the lightpath. Examples of lightpaths that can be handled by the WxC 110 include, but are not limited to, OC-48 (2.5 Gb/s), OC-192 (10 Gb/s), and OC-768 (40 Gb/s). The ADM 130 and the electronic IP switch/router 120 are used to communicate information bits between the lightpath crossing the WxC 110 and the ingress and egress ports of the node 100. To divert information bits from the lightpath to the node, the ADM 130 removes an incoming lightpath from the WxC 110 and de-multiplexes the low-rate (e.g., 625 Mb/s) traffic flows bundled in the lightpath. The de-multiplexed traffic flows are then switched by the electronic IP switch/router 120 to the egress destination ports of the node 100. To transmit information bits from the node 100 to the lightpath, the electronic IP switch/router 120 switches several incoming low-rate flows from the ingress access lines to the ADM 130. The ADM 130 aggregates and structures the flows into a full high-rate lightpath stream and then transmits the stream on an outgoing lightpath from the WxC 110.

For simplicity, the optical network element used to illustrate the preferred embodiments described herein takes the form of a WxC. However, a WxC should not be read into the following claims unless explicitly recited therein. An optical network element can take the form of any suitable apparatus that switches the wavelength of an incoming lightpath to the same or some other outgoing wavelength, connecting the two and establishing continuity of the communication stream between the two wavelengths on the lightpath. For example, a fiber switch utilizing micro-mirror technology can switch all the lightpaths/wavelengths of an incoming fiber to the corresponding ones of a single outgoing fiber of equal or greater capacity. Alternatively, the incoming lightpaths/wavelengths on a fiber can be de-multiplexed and spread across several outgoing fibers without any wavelength conversion, where they are optically multiplexed with other lightpaths carried on other wavelengths by other fibers. Additionally, with new wavelength conversion technologies maturing in the future, a lightpath of a particular wavelength on an incoming fiber can be switched in the optical domain to a different wavelength on some outgoing fiber. Furthermore, instead of switching exclusively in the optical domain, an optical network element can use an intervening electronic layer to perform wavelength-switching. In an optical-electronic-optical (O-E-O) element, the incoming optical signal on a wavelength is changed into an electronic one (e.g., through a photo-detector), and the resulting electronic signal drives a photo-transmitter (e.g., a laser), which changes the electrical signal back into an optical signal and transmits it on the same or some other wavelength on an outgoing fiber.

Reconfiguring Optical Network Elements

It is often desired to reconfigure the route of a lightpath in a network. For example, in backbone large-scale optical networks, lightpath routes can be reconfigured to adapt to varying traffic demands. Lightpaths are reconfigured by reconfiguring the WxCs along the lightpath. A WxC has the ability to reconfigure its input-output connectivity state by rearranging the outgoing fibers and wavelengths of incoming lightpaths from one feasible permutation to another. The continuity of some of the lightpaths traversing the WxC is temporarily cut during the time that the WxC dismantles a lightpath's current fiber and wavelength permutation state and re-establishes them in a different one. During this WxC reconfiguration time interval, any information bits carried on the lightpaths crossing the WxC are dropped due to the disruption of lightpath continuity and are not received by a destination node.

To eliminate the possibility of dropped bits during the reconfiguration of the WxC 110, it is preferred that the source node controls the transmission of information bits to the WxC 110 such that no information bits cross the WxC 110 during the WxC's reconfiguration time interval. In one preferred embodiment, the source node transmits a reconfiguration frame, and the WxC 110 is reconfigured when the reconfiguration frame crosses the WxC 110—not when information bits transmitted after the reconfiguration frame cross the WxC 110. As used herein, a transmission (e.g., a reconfiguration frame or information bits) crosses a WxC 110 after the leading edge of the transmission is received by the WxC 110 and before the trailing edge of the transmission exits the WxC 110. The term “reconfiguration frame” is intended to broadly refer to a transmission that is free of any information bits (e.g., a “gap” in the transmission of information bits) or that contains “expendable” information bits (i.e., information bits that do not have to be received by a destination node for a complete transmission). Examples of expendable information bits include, but are not limited to, random information bits or a repeat of information bits that have already been sent or will be sent (and, therefore, can be dropped without consequence). Accordingly, even if a reconfiguration frame is disrupted during the reconfiguration of the WxC 110, information bits intended for receipt by the destination node are not dropped.

In one preferred embodiment, the reconfiguration frame takes the form of a mere interruption (or gap) in the transmission of information bits. The electronic switch/router 120 can utilize its ability to control low-rate traffic streams in the electronic domain to regulate when information bits are transmitted into the lightpath by buffering the information bits, thereby creating a reconfiguration frame. After the reconfiguration frame is created and injected on the lightpath, the electronic switch/router 120 releases the buffered information bits. The electronic switch/router 120 can also sporadically buffer incoming information bits to coordinate their transmission with other control events, as described in more detail below. Because the electronic switch/router 120 operates on low-rate traffic coming into the node, it can readily handle the relatively small amount of information bits for storage. In contrast, the prior method described in the background section attempts to buffer high-rate lightpath flows, which sometimes cannot be efficiently buffered optically (because of the nature of the optical transmission medium) or electronically (because of the high-rate traffic). Accordingly, the method of this preferred embodiment offers more control as compared to the prior method.

In the embodiment described above, the instruction to reconfigure the WxC 110 came from some source other than the reconfiguration frame. For example, a reconfiguration instruction can be sent to the WxC 110 from a reconfiguration control engine, as described below. In another embodiment, the reconfiguration frame itself carries the reconfiguration instruction, and the WxC 110 is reconfigured when the WxC 110 receives the reconfiguration instruction carried by the reconfiguration frame. The reconfiguration instruction, which can be introduced by the source node 100 during an interruption in the transmission of the information bits, can include, for example, a header field (e.g., with a signature trace) and a trailer field (e.g., containing a synchronization trace to allow WxC port syncing after the reconfiguration).

There are several advantages associated with these preferred embodiments. In contrast to the slow legacy method of establishing a new lightpath in parallel with an existing lightpath, the method described above provides a faster, more agile approach to lightpath reconfiguration that minimizes bandwidth waste. Agile lightpath reconfiguration allows rapid provisioning and rearrangement of lightpaths in order to support a wide variety of distinct traffic patterns induced by dynamically-changing user traffic demands, which is an important goal for next-generation optical networks. In this way, lightpaths between arbitrary ingress and egress ports can be established upon request over much shorter time scales. Additionally, agile lightpath reconfiguration can (1) increase the aggregate network capacity (and, hence, the produced revenue for a given infrastructure investment), (2) alleviate performance bottlenecks and increase the quality of service perceived by network users by lowering their admission delay and increasing their reliability of service, and (3) increase the utilization of network resources and delay the need for infrastructure upgrades. Further, as described in more detail below, these preferred embodiments allow a seamless reconfiguration of lightpaths with minimal or no disruption of ongoing network operations.

The following examples illustrate the use of reconfiguration frames to transition from an initial lightpath configuration between various source and destination nodes to a target lightpath configuration between the same or other source and destination nodes. Concerns regarding disruption of network communication activity and bandwidth waste will be discussed in conjunction with these examples.

Example Using a Single WxC

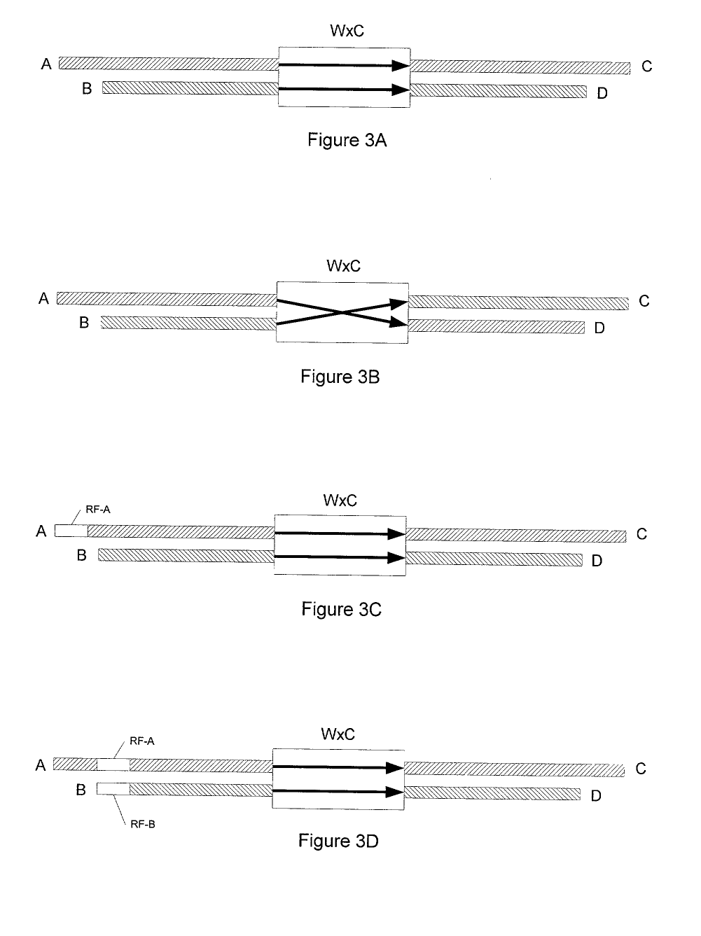

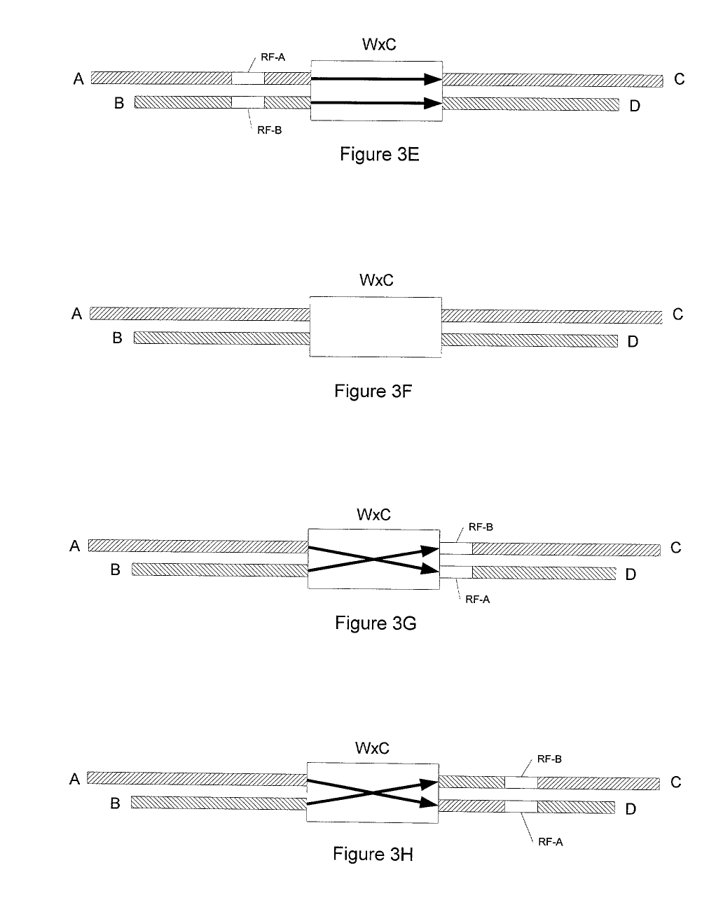

FIGS. 3A-H illustrate a method of a preferred embodiment using reconfiguration frames to reconfigure a single WxC that supports two lightpaths and four nodes. FIG. 3A illustrates the initial lightpath configuration in which one established lightpath connects source node A with destination node C, and another established lightpath connects source node B with destination node D. The hatchings shown in these figures represent continuity of the lightpaths do not necessarily correspond to wavelengths. For example, although the two segments of the lightpath from node A to C have the same hatching, the wavelength of the lightpath segment from node A to the WxC can be different from the wavelength of the lightpath segment from the WxC to node C. FIG. 3B illustrates the target lightpath configuration in which the WxC has been reconfigured to support a lightpath from node A to node D and a lightpath from node B to node C.

To transition from the initial to the target configuration without dropping information bits during the reconfiguration of the WxC, nodes A and B inject reconfiguration frames into the lightpaths of the initial lightpath configuration, and the WxC is reconfigured when the reconfiguration frames converge on the WxC. As shown in the figures, the lightpath connecting node A with the WxC is longer than the lightpath connecting node B with the WxC. Because of this difference in signal propagation time, nodes A and B preferably coordinate the injection of their respective reconfiguration frames so that the reconfiguration frames will converge at the WxC at the same time. Accordingly, node A interrupts its transmission of information bits and introduces its reconfiguration frame (RF-A) into its lightpath first (see FIG. 3C), and node B interrupts its transmission of information bits and introduces its reconfiguration frame (RF-B) into its lightpath at a later time (see FIG. 3D).

Reconfiguration frames RF-A and RF-B travel along their respective lightpaths (see FIG. 3E) and converge at the WxC (see FIG. 3F). While reconfiguration frames RF-A and RF-B cross the WxC, the WxC is reconfigured. As discussed above, the instruction to reconfigure the WxC can be carried by one or both of the reconfiguration frames or transmitted from some other source, such as a reconfiguration control engine. Since only the reconfiguration frames are disrupted by the lightpath discontinuity caused by the WxC changing its internal configuration, information bits in the lightpaths are not dropped. With the lightpaths reconfigured from parallel to cross connectivity, the reconfiguration frames emerge from the WxC and continue traveling on the outgoing lightpaths (see FIG. 3G). With the reconfiguration of the WxC complete, reconfiguration frames RF-A and RF-B (and the information bits transmitted after reconfiguration frames RF-A and RF-B) are now on route to nodes D and C, respectively, along the partially-reconfigured lightpaths (see FIG. 3H). Reconfiguration frames RFA and RF-B are eventually absorbed (“sinked”) at nodes D and C, respectively, thereby completing the target lightpath configuration.

Preferably, the time duration of reconfiguration frames RF-A and RF-B is at least as long as the reconfiguration interval of the WxC to ensure that information bits in the segments of the lightpaths leading to the WxC are not dropped. It may be preferred to increase the time duration of one of the reconfiguration frames to account for coordination jitter (e.g., clock skews) of the other. While there is no restriction on the maximum time duration of a reconfiguration frame (e.g., the duration of a reconfiguration frame can be larger than that of its lightpath), it may be preferred to design reconfiguration frames RF-A and RF-B as short as possible for high bandwidth utilization, low disruption, and high agility of the lightpath reconfiguration process. For example, designing reconfiguration frames RF-A and RF-B as short as possible can allow for establishing virtual multiple connectivity of a source node to several destination nodes. The network can cycle between the two lightpath configurations shown in FIGS. 3A and 3B by periodically injecting reconfiguration frames from source nodes A and B. While the frequent injection of reconfiguration frames does waste some bandwidth, the short duration reconfiguration frames enable statistical soft connectivity of A→C and A→D, as well as B→C and B→D, concurrently. The agility of this reconfiguration method allows such a frequent switching between the two configurations that even delay-sensitive video and voice traffic streams can be simultaneously supported across all four source-destination pairs.

To consider the efficiency of using reconfiguration frames, consider the example shown in FIGS. 3A-H applied to an optical backbone network of continental span (e.g., a carrier network spanning the United States or the European Union) with the average physical length of a fiber-supported lightpath segment (A→WxC, B→WxC, WxC→C, WxC→D) on the order of 100 Km-1000 Km. Given a fiber index of 1.5, the light speed on a lightpath segment is 200,000 Km/s (in vacuum 300,000 Km/s). Accordingly, the signal propagation time on each fiber is of the order of 0.5 ms-5 ms, and the average time-length of each lightpath (e.g., A→WxC→C) is of the order of 1 ms to 10 ms. If each lightpath is a 10 Gb/s OC-192 (40 Gb/s OC-768), the information in transit on each lightpath is 10 Mb-100 Mb (40 Mb-400 Mb). Given that a WxC may practically support thousands of lightpaths, there may be Tbs or more of information in transit on those lightpaths collectively. Since the reconfiguration time of a WxC is about 1 to 100 micro-seconds and since the reconfiguration frames preferably also last at least 1 -100 micro-seconds, reconfiguration frames “waste” only about 1% to 10% of the lightpath capacity during the transition from the initial to the target configuration.

Example with Multiple WxCs

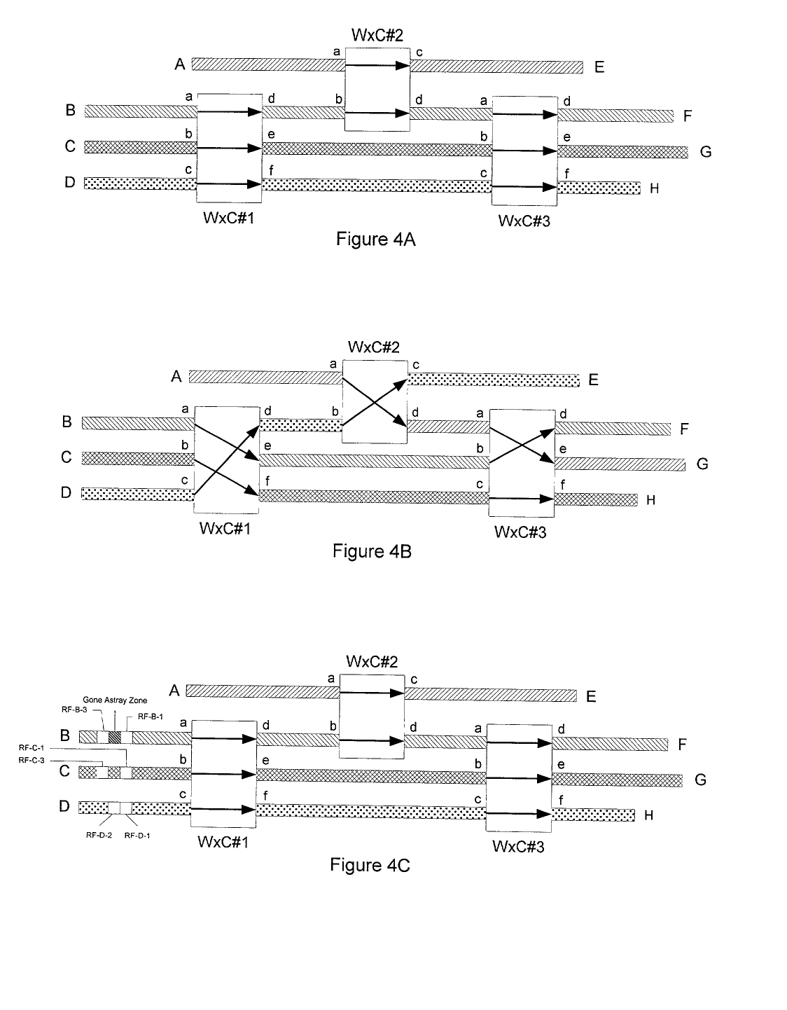

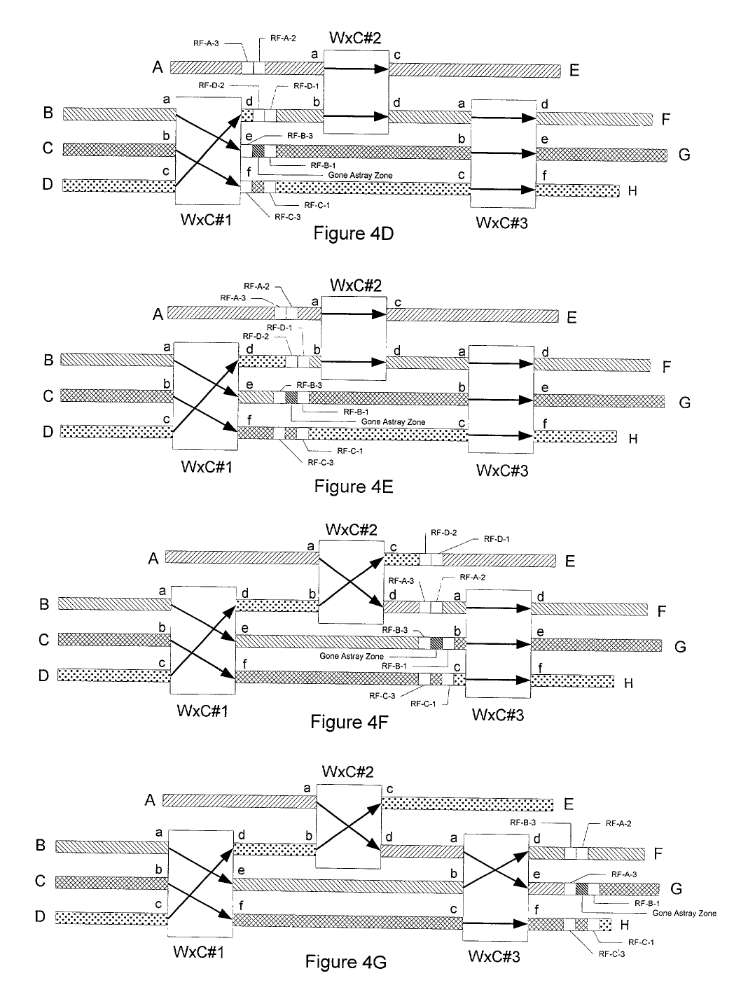

FIGS. 4A-G illustrate a method of a preferred embodiment using reconfiguration frames to reconfigure three WxCs supporting four lightpaths and eight nodes. As with FIGS. 3A-H, the hatchings shown in these figures represent continuity of the lightpaths and do not necessarily correspond to wavelengths. FIG. 4A illustrates the initial lightpath configuration (A→E, B→F, C→G, D→H), and FIG. 4B illustrates the target lightpath configuration (A→G, B→F, C→H, D→E). In both configurations, source node B is connected with destination node F, but the connection is supported by different lightpaths. To achieve the target configuration, source nodes A, B, C, and D inject multiple, WxC-specific reconfiguration frames into the lightpaths at times chosen such that the WxC-specific reconfiguration frames will simultaneously converge on their respective WxCs. Specifically, reconfiguration frames RF-B-1, RF-C-1, and RF-D-1 target WxC#1; reconfiguration frames RF-A-2 and RF-D-2 target WxC#2; and reconfiguration frames RF-A-3, RF-B-3, and RF-C-3 target WxC#3. FIGS. 4B-G show how the reconfiguration frames sweep through the WxCs and reconfigure the lightpaths to the target state.

In some situations, information bits transmitted between reconfiguration frames will not reach their intended destination node. Such sections between reconfiguration frames will be referred to as “gone astray zones.” The length of a gone astray zone depends on the time lengths of the various segments of the lightpaths between the various WxCs they traverse. FIGS. 4C-G illustrate the problems associated with gone astray zones. Referring to FIG. 4C, a gone astray zone is located between reconfiguration frames RF-B-1 and RF-B-3. As shown in FIGS. 4C-G, information bits transmitted before reconfiguration frame RF-B-1 will be delivered to the destination node in the initial configuration (destination node F), and information bits transmitted after reconfiguration frame RF-B-3 will be delivered to the destination node in the target configuration (destination node F). However, as shown in FIG. 4G, information bits transmitted in the gone astray zone will be delivered to destination node G—not to destination node F. Accordingly, it is preferred that the source node prevent information bits from being transmitted into a gone astray zone by buffering the information bits. It should be noted that not all sections between reconfiguration frames are necessarily gone astray zones. For example, the information bits transmitted by source node C between reconfiguration frames RF-C-1 and RF-C-3 reach their intended destination node (node H).

Lightpath Reconfiguration Control Engine

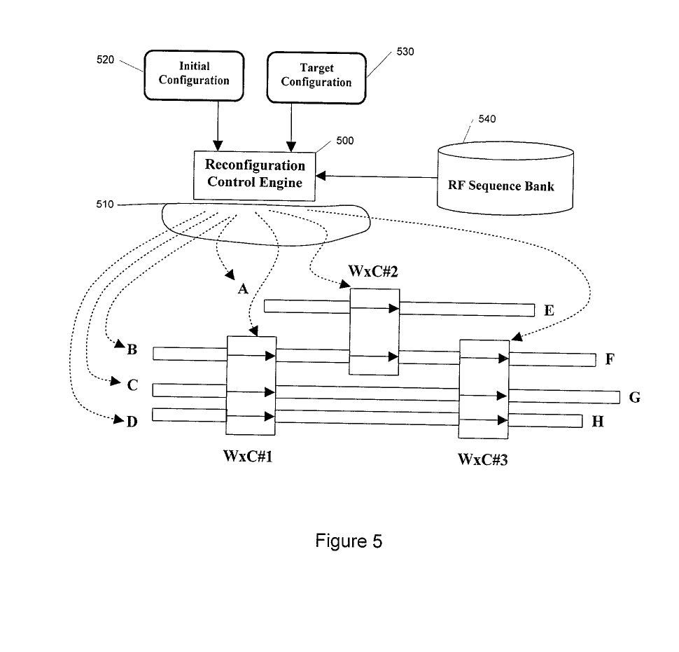

In one preferred embodiment, a lightpath reconfiguration engine is used to manage and execute the transition from an initial lightpath configuration to a target lightpath configuration by instructing each agent (e.g., a source node or a WxC) to implement its action steps. As shown in FIG. 5, the lightpath reconfiguration control engine 500 can take the form of a signaling server and processor running at a centralized network management node and communicating with the agents in the network though control channels 510. In operation, the reconfiguration control engine 500 receives a request for the reconfiguration of a set of lightpaths from some initial configuration 520 to a target configuration 530. The reconfiguration control engine 500 then runs an algorithm to compute action steps to be taken by each agent. For example, the reconfiguration control engine 500 can calculate the nature and timing of reconfiguration frames that need to be injected into the lightpaths to enable their transition, determine the instructions needed to be sent to the WxCs to enable their reconfiguration, and determine the instructions needed to prevent information bits from being transmitted in gone astray zones.

The reconfiguration control engine 500 then establishes a communication clique/session with the agents involved in the reconfiguration transition via the control channels 510, which can be low-rate physical or virtual control channels, and instructs the source nodes to inject appropriate reconfiguration frames at appropriate times. As described above, reconfiguration frames can be synthesized in the electronic domain of each source node by buffering low-rate flows with the electronic switch/router. In this way, the reconfiguration control engine 500 controls and coordinates reconfiguration frame injections into the lightpaths of the network by communicating with the control plane of the electronic switch/router of each node. The reconfiguration control engine 500 can also instruct the WxCs to switch at the appropriate times. Alternatively, the reconfiguration control engine 500 can instruct the source nodes to insert reconfiguration instructions in the reconfiguration frames.

Instead of running at a centralized network management node, the reconfiguration control engine can run at a master agent in a clique of transition agents. The agent nodes that are involved in the lightpath reconfiguration form a clique, and a leader/master election algorithm is used to select one of those agents as a master agent according to some optimization criterion, such as proximity to other agents. The selected master agent would implement the functionality of the reconfiguration control engine locally at that agent's node. The master agent then establishes a control channel with the other agents in the transition agent clique and runs a reconfiguration algorithm to determine the relative timing and sequencing of the reconfiguration frames that each source node should inject on the lightpath(s) it initiates and to determine the relative switching times of the WxCs. The master agent communicates the instructions to the corresponding agents, and the cascade of transition events is preferably scheduled to commence after some delay to give enough time to the agents to acknowledge receiving the information and to handle the rare possibility of lost messages via retransmissions. Communication between the master agent and the other agents can ride initially on a global network control channel, which would establish synchronization and absolute reference timing between the agents. As noted above, timing jitters and clock skew can be compensated by elongating the reconfiguration frames.

Reconfiguration Algorithms

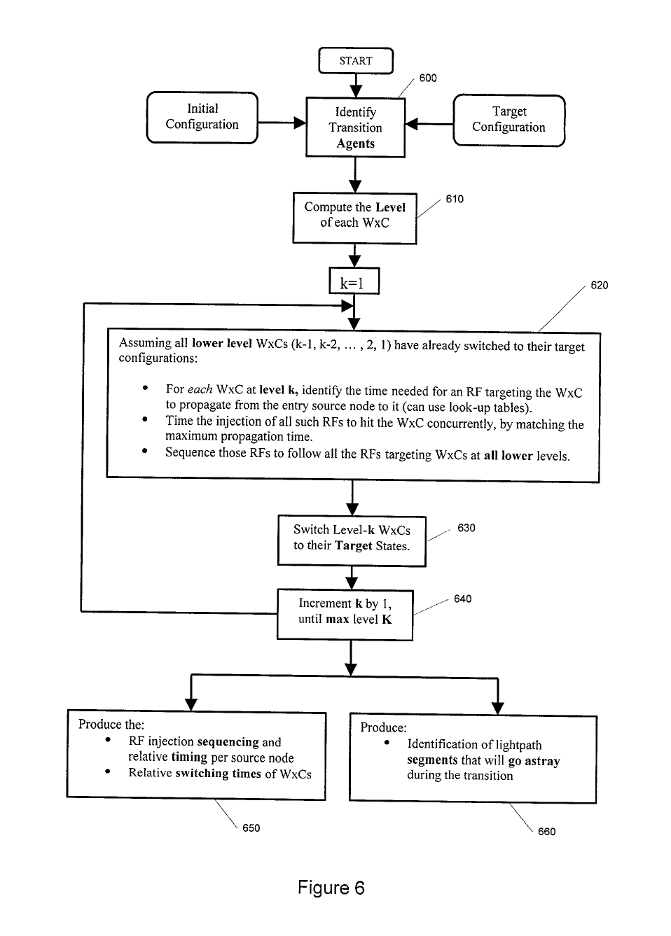

As discussed above, the reconfiguration control engine 500 runs a reconfiguration algorithm to compute action steps to be taken by each agent in transitioning from an initial lightpath configuration to a target lightpath configuration. An example of a “greedy” reconfiguration algorithm is shown in the flow chart of FIG. 6. This algorithm produces reconfiguration frame sequencing and relative injection timing as well as WxC switching timing information when the initial and target configurations are acyclic. An acyclic configuration is one in which no two nodes at the same level (as defined below) are both traversed by the same lightpath. As shown in FIG. 6, agents that will participate in the transition process are identified by examining initial and target lightpath configurations (act 600). In the network shown in FIG. 5, the transition agents are the WxCs that switch their states, as well as the source nodes that inject reconfiguration frames. Next, the level of each WxC is computed (act 610). The level of each WxC agent is the maximum number of WxCs (the one under consideration included) that a lightpath, starting from a source node, has to traverse to reach the WxC under consideration in the initial or target configuration. In the network shown in FIG. 5, WxC#1 is at level 1, WxC#2 is at level 2, and WxC#3 is at level 3. In more general topologies, there can be several WxCs at each level. The algorithm then enters a finite recursion loop indexed by the number of WxC levels, scanning those levels from 1 to the maximum number, K.

For each WxC at level k, the time needed for a reconfiguration frame targeting a WxC to propagate from its entry source node to the WxC is identified. The propagation times over the various segments of fiber and WxCs can be measured once (e.g., during the initial installation phase of the components) and stored in look-up tables that are disseminated throughout the nodes of the network. The algorithm times the injection of all such reconfiguration frames to hit the WxC concurrently by matching the maximum propagation time and then sequences those reconfiguration frames to follow all the reconfiguration frames targeting the WxCs at all lower levels (act 620). Next, the level k WxCs are switched to their target state (act 630), and k is incremented by 1 until the maximum level K (act 640). At the conclusion of this loop, reconfiguration frame injection sequencing and relative timing per source node is produced, as well as the relative switching times of the WxCs (act 650). Additionally, the lightpath segments that will go astray during the transition are identified (act 660).

This algorithm will now be demonstrated in conjunction with the network shown in FIG. 5 and the initial and target lightpath configurations shown in FIGS. 4A and 4B. The initial and target lightpath configurations can be mathematically represented as an ordered list of consecutive segments between source, destination, and WxC ports such that the whole configuration is a set of its individual lightpaths. The initial lightpath configuration is represented by the set {(A-2a)-(2c-E), (B-1a)-(1d-2b)-(2d-3a)-(3d-F), (C-2b)-(2e-3b)-(3e-G), (D-1c)-(1f-3c)-(3f-H)}, and the target lightpath configuration is represented by the set {(A-2a)-(2d-3a)-(3e-G), (B-1a)-(1e-3b)-(3d-F), (C-1b)-(1f-3c)-(3e-H), (D-1c)-(1d-2b)-(2c-E)}. WxC#1 is at level 1, WxC#2 at level 2, and WxC#3 at level 3. T(x-y) is the time length of the lightpath segment (x-y). Assuming that T(B-1a)=7 ms, T(C-1b)=5 ms, and T(D-1c)=3 ms, Tmax=max{T(B-1a), T(C-1b), T(D-1c)}=max {7, 5, 3}=7. Accordingly, in order for the reconfiguration frames to hit WxC#1 concurrently, they are injected at time Tmax—T(B-1a)=0 at node B, at time Tmax—T(C-1b)=2 ms at node C, and at time Tmax—T(D-1c)=4 ms at node D. The same mechanism would be applied for WxC#2 and WxC#3 by considering the time lengths of the sections of lightpaths that reach each one of those WxCx in the target configuration.

In the general case, T(s→x) is the time needed for light to propagate from source node s to WxC x in a target configuration, Sx is the set of all source nodes of lightpaths that traverse WxC x in the target configuration, and Xk is the set of all WxCs at level k. The reconfiguration frame injection algorithm proceeds as follows, (starting with level k=1, and T(0)=0):

(1) For each x in Xk, compute Tx=max{T(s→x), over all s in Sx};

(2) Inject reconfiguration frame for x into s at time T(s,x)={Tx−T(s→x)}+T(k-1);

(3) Update: T(k)=max{T(s,x), over all s in Sx and x in Xk}; and

(4) Update k←k+1 and go to (1) (exit when all levels have been scanned).

In the examples described above, no source (destination) node in the initial configuration becomes a destination (source) node in the target configuration. If a lightpath were to reverse its direction, the source (destination) node would eventually map to a destination (source) node, and the output (input) ports supporting it on the WxCs would map to input (output) ones. In this situation, the forward lightpath can be dismantled (“emptied”) and re-established (“filled”) in the reverse direction after switching the WxC ports accordingly.

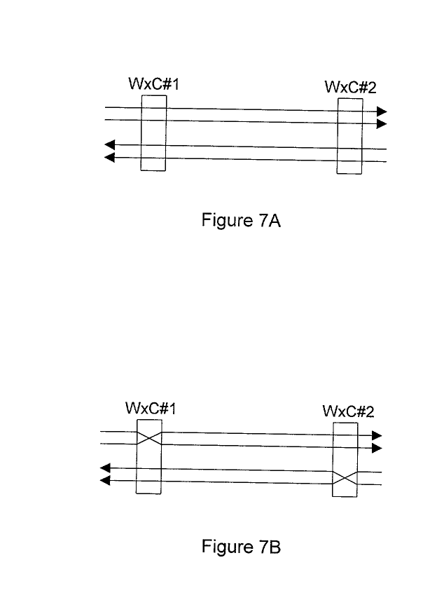

The algorithm above assumed that no two nodes at the same level are both traversed by the same lightpath. FIGS. 7A-B illustrate the situation in which the transition from an initial lightpath configuration to a target lightpath configuration is not acyclic since both WxCs are at level 2. In this situation, reference frames can be injected to induce the transition. However, in a more general case where cycles arise in a complicated lightpath configuration, one of the cycles can be broken by covering its lightpaths with appropriately long reconfiguration frames, thereby reducing the configurations to an acyclic one that can be used with the above algorithm.

The greedy algorithm presented above is just one baseline way of computing a feasible sequencing/timing of the reconfiguration frames and providing a feasible execution path for the method. However, there are many others. Consider now the space of all feasible reconfiguration frame sequences (that is, those that do not result in any dropping of information bits because they synchronize the reconfiguration frames to “cover” each WxC when it reconfigures). Based on operational considerations at higher layers of the network control architecture (for example, trying to minimize the disruption on real-time delay-sensitive video traffic supported on one lightpath, compared to delay-tolerant file transfers on another lightpath), a set of preferred reconfiguration frame sequences can be computed off-line by the network and stored in a reconfiguration frame sequence bank/database 540 (see FIG. 5). Preferred sequences can be those that are optimal (or near-optimal) given various cost and management considerations and information available in higher layers of the network control architecture. The reconfiguration control engine 500 has access to the reconfiguration frame sequence bank 540, and when a request for a reconfiguration transition appears, the reconfiguration control engine 500 pulls the appropriate reconfiguration frame sequence from the reconfiguration frame sequence bank 540 and coordinates the transition agents to implement it.

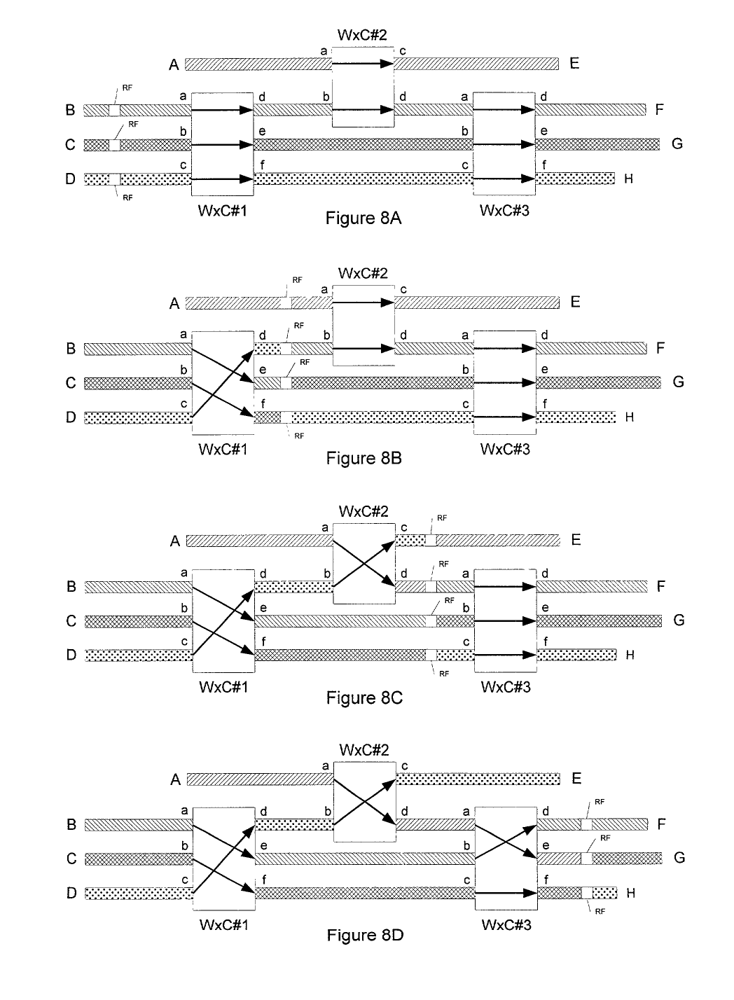

Another alternative to the greedy algorithm presented above minimizes the wasted bandwidth due to reconfiguration frames by maximizing the overlap of the reconfiguration frames targeting different WxCs. In the greedy algorithm presented above, reconfiguration frames for different WxCs were injected sequentially. To avoid consuming bandwidth unnecessarily, reconfiguration frames can be injected concurrently for all WxCs (when the fibers have time lengths that support this approach). This is illustrated in FIGS. 8A-D, where a single set of reconfiguration frames RF—one per lightpath—sweeps through the network, converging on each WxC to allow it to switch to its target configuration. It should be noted that under this approach, there are no gone astray zones, thereby providing additional optimization. As this alternative illustrates, if a lightpath participating in a reconfiguration traverses N WxCs, then N reconfiguration frames (one for each WxC) are injected on this lightpath in the worst case. On the contrary, only a single reconfiguration frame (recycled on each WxC) may be enough in the best case. In the general case, a variable number of reconfiguration frames will be needed on each lightpath, and natural optimization objectives are to minimize the aggregate number of reconfiguration frames on all lightpaths collectively or, alternatively, to minimize the maximum number of reconfiguration frames on each individual lightpath. This optimization can be done off-line, and the optimal reconfiguration frame sequencing and timing can be prestored in tables/banks to be retrieved and executed when needed.

The following is a discussion of worst case performances for various WxC technology classes (i.e., where individual reconfiguration frames are injected sequentially for each WxC that the lightpath crosses). Consider a realistic and stressing reference scenario in which a lightpath stretching from LA to NYC (almost the maximum geographical span in the U.S.) traverses ten WxCs on a core/backbone nework. There are design pressures to have end-to-end communication sessions traverse only a small number of switching nodes for overhead reasons. For example, in today's Internet, most sessions traverse less than ten switches/routers (and hops) end-to-end, while the number of hops on the backbone is even smaller. (The hop-count can be tracked and used for routing purposes.) A similar situation arises in current circuit-switched telephone networks. Ten hops is a reasonable medium/high estimate for an optical backbone/core network, and there can be more switching elements that end-to-end, individual-user, lowr-ate sessions will traverse at lower levels of the network routing hierarchy (metro, campus, local, personal).

The following performance analyses are done on a lightpath of 5000 Km (LA-to-NYC) traversing ten WxCs. Note that the equivalent time-length of the lightpath is 25 ms (for lightspeed on the fiber of 200 Km/sec—index 1.5), and the lightpath is OC-192 (10 Gb/s) or OC-48 (2.5 Gb/s). Assuming a 10% bandwith waste is tolerated (i.e., there is no incentive to optimize the reconfiguration frames if they waste less than 10% of the lightpath bandwidth in the worst case), the method described above can easily tolerate individual WxC reconfiguration times of 0.25 ms (or 250 micro-secs).

Bufferless O-E-O WxCs

In the family of bufferless O-E-O WxCs technologies, the incoming optical signal on the lightpath is turned into an electronic one (e.g., through photodiode technology) and fed to the input port of a bufferless electronic/silicon switching fabric (e.g., a cross-bar switch of the ATM or other technology family), which switches it to one of its output ports. The latter electronic signal drives a laser (fixed-wavelength, non-tunable), which turns the signal into an optical one and injects it on the outgoing fiber wavelength (which may be the same as or different from the incoming wavelength) establishing the continuity of the lightpath. Such silicon switching fabrics can reconfigure in nano-second time scales. For example, with ATM-family cross-bar switches operating at 2.5 Gb/sec, a whole ATM-like cell of 53 bytes (with 8 bits/byte) would have a time-length of 53×8×0.4 ns/bit=169.6 ns/cell. If an O-E-O WxC reconfigures in 500 ns (i.e., if the time needed to reconfigure the electronic fabric and pick-up signal synchronization at the output laser (non-tunable, fixed-wavelength is 500 ns), then each reconfiguration frame is 500 ns. Accordingly, in the worst case scenerio, for 10 WxCs, the total waste is 5 micro-secs of bandwidth from a total of 25 ms, which is 1/5000 of the total bandwith of the lightpath. Accordingly, with this technology, the bandwidth waste is so negligible that minimizing bandwidth waste by overlapping reconfiguration frames may not be preferred. With this technology, even 100 WxCs along the lightpath can be used with neglible bandwidth waste.

MEMS Micro-Mirror WxCs

The family of technologies based on MEMS Micro-Mirror WxCs is not fully mature yet but is improving fast. Current commercial products (e.g., Lucent lambda-switch) target high port-count of 1024×1024 or more rather than higher switching speeds because they aim to be used for switching wavelengths over whole fibers (that is, act as fiber switches). For such products, 1-10 ms switching speeds are reported. However, experimental prototypes have already demonstrated switching speeds of less than 700 micro-secs using free-rotating hinged micro-mirrors (see “Free-Space Micromachined Optical Switches with Submillisecond Switching Time for Large-Scale Optical Cross-Connects,” L. Y. Lin et al., IEEE Photonics Technology Letters, vol. 10, no. 4, April 1998, which is hereby incorporated by reference) and switching speeds of less than 600 micro-secs using stress-induced curved poly-silicon actuators (see “A High-Speed Low-Voltage Stress-Induced Micromachined 2×2 Optical Switch,” Chen et al., IEEE Photonics Technology Letters, vol. 11, no. 11, November 1999, which is hereby incorporated by reference). The trend is towards shortening the switching times of micro-mirrors by using both novel mirror architectures and oscillation dampening mechanisms. Over the next few years, switching speeds of whole fiber switches may drop below 250 micro-secs or even 100 micro-secs, in which case they will be comfortably within the domain of the bandwidth waste zone that needs no optimization of reconfiguration frames (i.e., less than 10% waste). Until then, optimizing the system by overlapping the reconfiguration frames of various WxCs as much as possible will be useful.

Integrated Optical Waveguide Based WxCs

Integrated optical waveguide-based WxCs is an emerging techology and has already been demonstrated on experimental prototypes in industrial and academic research labs. Integrated optical waveguide-based WxCs allow optical cross-connect of input/output ports and switching at nano-second speeds (1-100 ns). They are primarily being developed for optical packet switching, but variants can also be used for WxCs that are appropriately amended and scaled up in terms of port-count and power. For example, switching speeds of less than 200 pico-secs are reported in “Low-Loss Polarization-Insensitive InP-InGaAsP Optical Space Switches for Fiber Optical Communication,” R. Krahenbuhl et al., IEEE Photonics Technology Letters, vol. 8, no. 5, May 1996, which is incorporated by reference. Again, for such fast switching technologies, there may not be a need to optimize the reconfiguration frames.

Tunable Filters/Lasers

There are tunable filter and laser technologies that have been demonstrated on experimental prototypes to switch in micro-sec speeds, although commercial products today, which target wide-range tunability, operate at milli-second speeds. It can be expected that the latter will eventually drop to 100 micro-secs.

Hybrids

Further, there is also the possibility that the lightpath can traverse WxCs that belong to different technology classes (i.e., hybrids).

To conclude, for the “stressful” scenario presented above, if the WxCs can reconfigure in 100 micro-secs each, then only 1/25 of the lightpath bandwidth is wasted in the reconfiguration (given that the lightpath stretches over 5000 Km and traverses 10 WxCs) in the worst case.

In the examples described above, all lightpaths were active and carried traffic. In the situation where there are free lightpaths, additional degrees of freedom are introduced in managing the transition from an initial lightpath configuration to a target lightpath configuration. However, in a highly-utilized network, especially at its congestion “hot spots” and capacity bottlenecks, efficient transitioning between “dense” configurations becomes very important for network performance.

While an optical network element has been used in the embodiments set forth above, it should be noted that reconfiguration frames can be used with any type of configurable network element, optical or otherwise. For example, a reconfiguration frame can be transmitted from a source node to an electronic network element (e.g., an electronic switch) via a non-lightpath traffic path (e.g., a copper wire). When the reconfiguration frame crosses the electronic network element, the electronic network element is reconfigured. For example, a cross-bar switch can be reconfigured to connect an input port with a different output port. Like an optical network element, an electronic network element can drop information bits that cross the electronic network element during reconfiguration. Accordingly, the use of a reconfiguration frame ensures that information bits transmitted in the traffic path by the source node are not dropped when the electronic network element is reconfigured.

Lastly, it should be noted that these preferred embodiments provide advantages with both buffer-free network elements and buffer-limited network elements. While a buffer-limited network element can store some information bits during the reconfiguration process, it has a relatively-low buffering capacity with respect to the traffic stream traversing it. That is, a very large buffer is needed to delay the traffic by even a short period of time given its high bit rate. For example, in the future, if nano-electronic technologies allow the design and production of electronic switching fabrics that can switch 160 Gb/s traffic streams through the electronic fabric but memory technologies cannot buffer the streams adequately, information bits will be lost during the reconfiguration of the electronic network element. A properly-sized reconfiguration frame can avoid dropped bits. If the network element can buffer traffic on a stream for a time period Tb and time Tr is required to reconfigure the network element, a reconfiguration frame of time-size Tr-Tb can be transmitted from a source node to avoid dropping information bits transmitted in the same traffic path by the source node (assuming that the buffer is empty at the beginning of the reconfiguration process).

It is intended that the foregoing detailed description be understood as an illustration of selected forms that the invention can take and not as a definition of the invention. It is only the following claims, including all equivalents, that are intended to define the scope of this invention.

What is claimed is:

1. A method for reconfiguring an optical network element, the method comprising:
(a) transmitting a reconfiguration frame from a source node to an optical network element via a lightpath; and
(b) reconfiguring the optical network element while the reconfiguration frame crosses the optical network element, whereby information bits transmitted by the source node after the reconfiguration frame are not dropped when the optical network element is reconfigured.

2. The invention of claim 1 further comprising, after (a) but before (b), transmitting information bits from the source node to the optical network element via the lightpath.

3. The invention of claim 1, wherein the optical network element comprises a wavelength cross-connect.

4. The invention of claim 1 further comprising creating the reconfiguration frame by buffering incoming information bits with an electrical network element at the source node.

5. The invention of claim 4, wherein the electrical network element comprises a switch.

6. The invention of claim 4, wherein the electrical network element comprises a router.

7. The invention of claim 1, wherein the reconfiguration frame comprises a reconfiguration instruction, and wherein the optical network element is reconfigured after receiving the reconfiguration instruction.

8. The invention of claim 1, wherein the optical network element is reconfigured in response to an instruction from a reconfiguration control engine.

9. The invention of claim 1 further comprising transmitting an additional reconfiguration frame from a second source node to the optical network element via a second lightpath, the transmission of the additional reconfiguration frame being timed such that the first-mentioned and additional reconfiguration frames cross the optical network element at the same time; and wherein (b) comprises reconfiguring the optical network element while the first-mentioned and additional reconfiguration frames cross the optical network element.

10. A optical communication network comprising:
a source node;
an optical network element; and
a lightpath connecting the source node with the optical network element;
wherein the source node is operative to transmit a reconfiguration frame to the optical network element via the lightpath and wherein the optical network element is operative to be reconfigured while the reconfiguration frame crosses the optical network element.

11. The invention of claim 10, wherein the source node is further operative to transmit information bits to the optical network element via the lightpath after transmitting the reconfiguration frame.

12. The invention of claim 10, wherein the optical network element comprises a wavelength cross-connect.

13. The invention of claim 10, wherein the source node comprises an electrical network element operative to create the reconfiguration frame by buffering incoming information bits.

14. The invention of claim 13, wherein the electrical network element comprises a switch.

15. The invention of claim 13, wherein the electrical network element comprises a router.

16. The invention of claim 10, wherein the source node comprises an optical network element, an add-drop mulitplexor, and an electronic network element.

17. The invention of claim 10, wherein the reconfiguration frame comprises a reconfiguration instruction, and wherein the optical network element is reconfigured after receiving the reconfiguration instruction.

18. The invention of claim 10 further comprising a reconfiguration control engine connected with the optical network element, wherein the reconfiguration control engine is operative to transmit a reconfiguration instruction to the optical network element.

19. The invention of claim 10 further comprising a second source node operative to transmit an additional reconfiguration frame to the optical network element via a second lightpath, the transmission of the additional reconfiguration frame being timed such that the first-mentioned and additional reconfiguration frames cross the optical network element at the same time, and wherein the optical network element is further operative to be reconfigured while the first-mentioned and additional reconfiguration frames cross the optical network element.

20. A method for transitioning from an initial lightpath configuration to a target lightpath configuration in an optical communication network, the method comprising:
(a) receiving initial and target lightpath configurations;
(b) instructing source nodes to transmit reconfiguration frames, the transmission of the reconfiguration frames timed such that the reconfiguration frames will cross an optical network element at the same time; and
(c) instructing the optical network element to reconfigure while the reconfiguration frames cross the optical network element.

21. The invention of claim 20, wherein (a)-(c) are performed at a central network management node.

22. The invention of claim 20, wherein (a)-(c) are performed at a master agent in a clique of transition agents.

23. The invention of claim 22, wherein the master agent comprises a source node.

24. The invention of claim 22, wherein the master agent comprises an optical network element.

25. The invention of claim 20, wherein the optical network element comprises a wavelength cross-connect.

26. The invention of claim 20 further comprising creating the reconfiguration frames by buffering incoming information bits with electrical network elements at the source nodes.

27. A method for reconfiguring a network element, the method comprising:
(a) transmitting a reconfiguration frame from a source node to a network element via a traffic path; and
(b) reconfiguring the network element while the reconfiguration frame crosses the network element, whereby information bits transmitted by the source node after the reconfiguration frame are not dropped when the network element is reconfigured.

28. The invention of claim 27, wherein the network element comprises an optical network element.

29. The invention of claim 28, wherein the optical network element comprises a wavelength cross-connect.

30. The invention of claim 28, wherein the traffic path is carried on an optical fiber.

31. The invention of claim 27, wherein the network element comprises an electrical network element.

32. The invention of claim 31, wherein the traffic path is carried on an electrical wire.

33. The invention of claim 27 further comprising, after (a) but before (b), transmitting information bits from the source node to the network element via the traffic path.

34. The invention of claim 27 further comprising creating the reconfiguration frame by buffering incoming information bits with an electrical network element at the source node.

35. The invention of claim 34, wherein the electrical network element comprises a switch.

36. The invention of claim 34, wherein the electrical network element comprises a router.

37. The invention of claim 27, wherein the reconfiguration frame comprises a reconfiguration instruction, and wherein the network element is reconfigured after receiving the reconfiguration instruction.

38. The invention of claim 27, wherein the network element is reconfigured in response to an instruction from a reconfiguration control engine.

39. The invention of claim 27 further comprising transmitting an additional reconfiguration frame from a second source node to the network element via a second traffic path, the transmission of the additional reconfiguration frame being timed such that the first-mentioned and additional reconfiguration frames cross the network element at the same time; and wherein (b) comprises reconfiguring the network element while the first-mentioned and additional reconfiguration frames cross the network element.
